(19) United States
(12) Patent Application Publication
(10) Pub. No.: US 2004/0073474 A1
(43) Pub. Date: Apr. 15, 2004

(54) Method for creating a multi-level business alliance

(76) Inventors: Denis Field, Wilmette, IL (US); Pamela Packard, Greenwich, CT (US); Daniel Balliel, Wilmette, IL (US); Michael O'Hare, Plano, TX (US); James Hannon, Lona Beach, NY (US); James Cross, Collierville, TN (US)

Correspondence Address: MORGAN LEWIS & BOCKIUS LLP, 1111 PENNSYLVANIA AVENUE NW, WASHINGTON, DC, 20004, US

(21) Appl. No.: 09/836,862

(22) Filed: Apr. 18, 2001

Related U.S. Application Data
(60) Provisional application No. 60/264,734, filed on Jan. 30, 2001.

(51) Int. Cl. G06F 17/60

(52) U.S. Cl. 705/10

(57) ABSTRACT

A method for creating a multi-level business alliance in non-exclusive geographical areas. The multi-level alliance includes a founding firm, and at least one foundation firm. The alliance also may include firms at other levels. Alliance members share resources, clients and revenue based on a predefined formula. This enables multiple firms to work together and provide a broader range of services to each other's clients while remaining independent of each other. Moreover, it enables smaller alliance members to have access to the resources of larger members and vice versa.

This application claims the benefit of U.S. Provisional Application No. 60/264,734, filed on Jan. 30, 2001.

### FIELD OF THE INVENTION

The present invention relates to a method for creating a business alliance within an industry, and more particularly to a method for creating a multi-level business alliance within industries that provide services to professional and financial services industries.

### BACKGROUND OF THE INVENTION

In the current business environment, large accounting firms are gaining market share by merging with or buying other accounting firms. Financial services firms, such as American Express, act as consolidators by acquiring other financial services firms or accounting firms. While the current movement in the financial service industry is consolidation among financial services firms and accounting firms, the merger of other industries, such as law firms or brokerage firms, with financial services firms and accounting firms is foreseeable. While consolidation is desirable for some industry participants, other participants want to retain their independence and still remain competitive. To remain competitive, however, market participants must have access to all of the resources that are available to larger firms. Moreover, a problem with mergers is that there are usually cultural changes that participants must experience.

Additionally, some firms may want to provide better services and/or increase their revenue by broadening their influence to geographical regions where they do not have a physical presence. However, based on some firms' economic models, there are locations where it is not economically feasible to create a physical presence.

Therefore, some financial services firms and accounting firms are beginning to form engagement-specific relationships, whereby based on predetermined formulas, they share resources and revenue while remaining independent of each other. For example, a first firm in a relationship may have access to the client base and other resources of a second firm in the relationship. In return for the access, the second firm is paid a fee. Moreover, clients of the second firm may have access to additional services provided by the first firm. In another example, the first firm may provide the second firm access to the first firm's client. However, due to restrictions, such as regulatory restrictions, the second firm may be prohibited from providing fees to the first firm. Nevertheless, the firms may gain revenue by working together.

Usually firms form engagement-specific relationships with others in different geographical locations. This enables a firm to have a business presence in geographical areas where it does not have a physical presence. Thus, firms may form relationships to cover existing businesses in areas where they do not have a physical presence or to avoid losing market opportunities.

Even though firms usually form relationships in geographically exclusive areas, i.e., geographical areas where each firm in the relationship has an exclusive physical presence, clients normally do not switch between firms in the same geographical area. In fact, firms within the same geographical area usually cooperate with each other. For example, a first firm may refer a client to a second firm so that the client may obtain complementary services from the second firm that the first firm does not provide. In return for the referral, the second firm, where permitted by regulation or law, shares the revenue obtained from the client with the first firm. For example, the second firm pays the first firm a referral fee or some other form of compensation. Additionally, a firm within a geographical area may complement another firm in the same area by providing access to personnel and other resources at reduced rates.

While engagement-specific relationships are beneficial to the firms involved, these relationships are usually short-term relationships. Therefore, firms must enter into new relationships for engagements not covered by prior relationships. These relationships may be complex and usually are costly to negotiate. Moreover, firms cannot rely on resources from current relationships to enter into future engagements.

What is needed therefore, is a method of creating long-term relationships whereby firms can share resources with other firms in the any geographical area while remaining independent.

### SUMMARY OF THE INVENTION

Accordingly, it is an object of the present invention to provide various methods for creating a multi-level business alliance. The methods are used to create an alliance between a plurality of independent firms based on predefined rules, wherein the predefined rules determine each firm's position in a multi-level alliance structure. Each method includes steps of requiring each firm that is not in the highest level of the alliance structure to pay a licensing fee, wherein predefined rules are used to divide the licensing fee between parent firms, i.e. firms in higher levels of the alliance structure that introduced the firm paying the fee to the alliance structure; providing each firm in the alliance structure an opportunity to access the resources of other firms in the alliance structure; and anticipating each firm in the alliance to provide a service that is desirable to current alliance firms.

It is another object of the invention to provide a method for creating a multi-level business alliance in non-exclusive geographical areas. Alliance members share resources and they generally share revenue based on a predefined formula. This enables multiple firms to work together and provide a broader range of services to each other's clients while remaining independent of each other.

It is another object of the invention to require that an alliance member potentially provide a service that adds value to current alliance members.

It is another object of the invention for each alliance to have one founding firm, which sets up the alliance, and at least one foundation firm as an alliance member. Any criteria, as defined by the founding firm, may be used for determining the foundation firm.

It is another object of the invention for the founding firm or the foundation firm to sign up a second level firm. The second level firm is generally smaller than the signing firm, i.e., the founding firm or the foundation firm that introduces the second level firm to the alliance.

It is another object of the invention for the second level firm to sign up a third level firm.

It is another object of the invention for the level of each firm to affect only how revenue is shared in the multi-level alliance. Revenue sharing may be established based on any criteria established by all or some of the alliance members and/or a third party.

Additional features and advantages of the invention will be set forth in the description that follows, and in part will be apparent from the description, or may be learned by practice of the invention. The objectives and advantages of the invention will be realized and attained by the method particularly pointed out in the written description and claims hereof as well as the appended drawings.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 illustrates an example of a multi-level business alliance; and

FIG. 2 illustrates the steps implemented in creating the multi-level business alliance of FIG. 1.

### DESCRIPTION OF THE PREFERRED EMBODIMENTS

Reference will now be made in detail to the preferred embodiments of the present invention, examples of which are illustrated in the accompanying drawings. The present invention described below extends the functionality of the inventive method for setting up a multi-level business alliance.

The present invention relates to a method for creating a multi-level business alliance in non-exclusive geographical areas. In this invention, alliance members in the same and different geographical areas share resources and they generally share revenue based on a predefined formula and based on each member's position in the multi-level alliance structure. For example, in one embodiment of the invention, if a first alliance member is capable of providing a service to a second member's client, the second member may refer the client to the first member for the service. The second member may retain the client for all other services and based on the second member's position in the multi-level alliance structure, the second member may receive a portion of the revenue paid by the client to the first member. The second member may refer the client to the first member for any reason. For example, the second member may not be able to provide the service required or the second member may not have sufficient personnel to service the client at a particular time. It should be obvious to those skilled in the art that alliance members may provide the same services and complement each other by providing more resources to perform these services.

In another embodiment of the invention, revenue may be shared between members in all levels of the multi-level alliance structure. For example, if a member in a first level of the alliance structure performs a service for a client of a member in a second level of the alliance structure, the member in the first level pays the member in the second level a referral fee, such as twenty-percent of the revenue received. If the member in the first level of the alliance structure performs a service for a client of a member in the third level of the alliance structure, the member in the first level pays a referral fee to the member in the third level and the member in the second level that introduced the third level member to the alliance. For example, the member in the first level may pay a fifteen-percent referral fee to the member in the third level and a five-percent referral fee to the member in the second level.

The multi-level business alliance thus enables multiple firms to work together and form long-term relationships and provide a broader range of services to each other's clients while remaining independent of each other. Moreover, it enables smaller alliance members to have access to the resources of larger members.

In a preferred embodiment of the invention, to become an alliance member a firm may be required to provide a service that adds value to alliance members. Once a firm becomes an alliance member, the firm is given an opportunity to access the resources of other alliance members. Revenue is shared between alliance firms based on their level in the multi-level alliance structure.

Preferably, alliance members may be financial services firms; but they also could be firms from outside the financial services industry. For example, accounting firms may form an alliance to share tax services and other resources with each other. Additionally, information technology firms may form another alliance and they also may share resources with each other and with the alliance of accounting firms. Therefore, it should be obvious to those skilled in the art that firms in different industries may form different alliances to share resources with each other and with firms in other alliances.

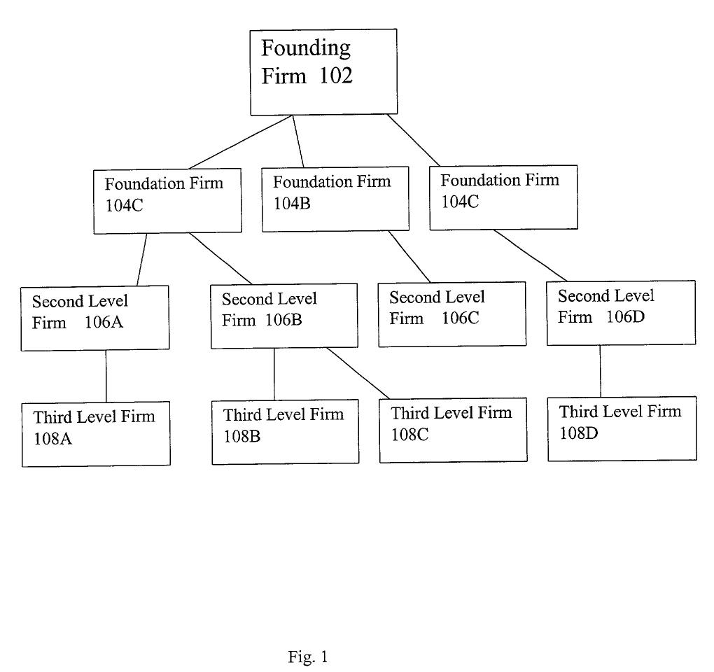

FIG. 1 illustrates a preferred structure of a multi-level alliance. The multi-level alliance of FIG. 1 includes a founding firm 102, a group of foundation firms 104, a group of second level firms 106, and a group of third level firms 108. Founding firm 102 forms the alliance and uses predetermined rules to assign other firms in the alliance to different revenue-sharing levels in the multi-level structure.

Specifically in the invention, to create an alliance, founding firm 102 creates an alliance with one or more foundation firms 104. Preferably, each of the foundation firms 104A-104C is a firm that is not in the same geographical area as founding firm 102 or it is a firm of a predetermined size in the same geographical area as founding firm 102. For example, foundation firms 104A-104C that are in same geographical area as founding firm 102 may be required to have revenue of a predefined amount, for example, ten million dollars. It should be noted that the size of each foundation firm 104A-104C may vary from one geographical area to the next, depending on the size of founding firm 102 in the same geographical area. There also may be multiple foundation firms 104A-104C in the same geographical area. As would be obvious to one skilled in the art, other criteria may be used for determining a foundation firm.

Founding firm 102, and/or each foundation firm 104A-104C, may sign up second level firms 106A-106D. Each second level firm 106A-106D generally is smaller than the signing firm, i.e., the foundation firms 104A-104C or founding firm 102 that introduces the second level firms 106A-106D to the alliance. Thereafter, each second level firm 106A-106D may sign up third level firms 108A-108D. Each third level firm 108A-108D generally is smaller than the signing second level firms 106A-106D, i.e., the second level firms 106A-106D that introduce the third level firm 108A-108D to the alliance. Each signing firm is a parent firm for firms in lower levels of the alliance structure that were introduced by the signing firm. Thus, foundation firm 104A is a parent of firms 106A and 108A and second level firm 106A is a parent of third level firm 108A. The founding firm 102, the foundation firms 104, the second level firms 106 and the third level firms 108 are all alliance members that may share resources. Alliance members may also share employees at predefined reduced rates.

While it is preferred that a firm's level within a multi-level alliance is based on the firm's size and/or geographical location, it should be noted that other criteria may be used to determine firms' levels in the alliance. For example, if a second level firm 106A introduces a larger firm to the alliance, the larger firm may be classified as a second level firm by founding firm 102. However, when revenue is shared with the larger firm, the larger firm is classified as a third level firm, i.e., a child of second level firm 106A that introduced the larger firm to the alliance, but only as it relates to revenue-sharing with the 106A firm that introduced the larger firm to the alliance.

In the preferred embodiment of the invention, the level of each firm only affects how revenue is shared in the multi-level alliance. Revenue sharing also is determined by the laws in each state or jurisdiction where there is an alliance member or by the type of service performed. For example, in some jurisdictions revenue sharing is not allowed. Thus, alliance members in those jurisdictions do not share revenue but are compensated by other means that are allowable under the law. It also should be noted that revenue sharing may be established based on any criteria defined by all or some of the alliance members and/or by a third party.

In the present invention, after founding firm 102 signs up each foundation firm 104A-104C, each foundation firm 104A-104C pays founding firm 102 a licensing fee. Thereafter, foundation firms 104A-104C and founding firm 102 share resources. Foundation firms 104A-104C and founding firm 102 also share revenue based on a predetermined formula. For example, if a foundation firm 104A refers one of its client to founding firm 102, founding firm 102 pays a percentage, such as twenty percent, of the revenue to foundation firm 104A for the referral.

Based on a predetermined formula, a signing foundation firm 104A and founding firm 102 share the licensing fees paid by second level firms introduced to the alliance by foundation firm 104A. For example, if signing foundation firm 104A is a parent firm of second level firm 106A then foundation firm 104A may evenly divide with founding firm 102, the licensing fees from the second level firms 106 introduced to the alliance by foundation firm 104A. Similarly based on a predetermined formula, second level firm 106A, foundation firm 104A that introduced the second level firm 106A to the alliance, and founding firm 102 share the licensing fees paid by third level firms 108 introduced to the alliance by the second level firm 106A.

In an embodiment of the inventive method, when alliance members, except for founding firm 102, refer clients to each other, the members may establish an acceptable referral fee agreement. For example, if a second level firm refers a client to foundation firm 104A, foundation firm 104A and the second level firm 106A may set up a referral fee agreement between themselves. In another embodiment, when alliance members, except for founding firm 102, refer clients to each other, the members must pay a percentage of the referral to the founding firm and they may establish an acceptable referral arrangement for themselves.

However, when founding firm 102 gets a client from a second level firm's client, founding firm 102 uses a predetermined formula to split the referral fee between the second level firm 106 and the foundation firm 104 that introduced the second level firm to the alliance. For example, if founding firm 102 gets a client from second level firm 106A clients, and firm 106A is not participating in providing service to the client, founding firm 102 keeps eighty percent of the revenue and gives fifteen-percent to second level firm 106A and five-percent to foundation firm 104A. Similarly, when founding firm 102 performs a service for a third level firm's client, founding firm 102 uses a predetermined formula to split the referral fee between the third level firm 108, the second level firm 106 that introduced the third level firm to the alliance, and the foundation firm that 104 introduced the second firm to the alliance. For example, if founding firm 102 works for one of third level firm 108A clients, founding firm 102 keeps eighty percent of the revenue, gives fifteen percent to the third level firm 108A, two thirds of the remaining five percent to second level firm 106A and one third of the remaining five percent to foundation firm 104A.

In another embodiment, if founding firm 102 gets a client from a second level firm 106 client and 106 firm also provides service to the client, the founding firm 102 and the second level firm 106 simply share the revenue as a simple fee splitting arrangement. Foundation firm 104 would not receive any type of referral fee in this instance.

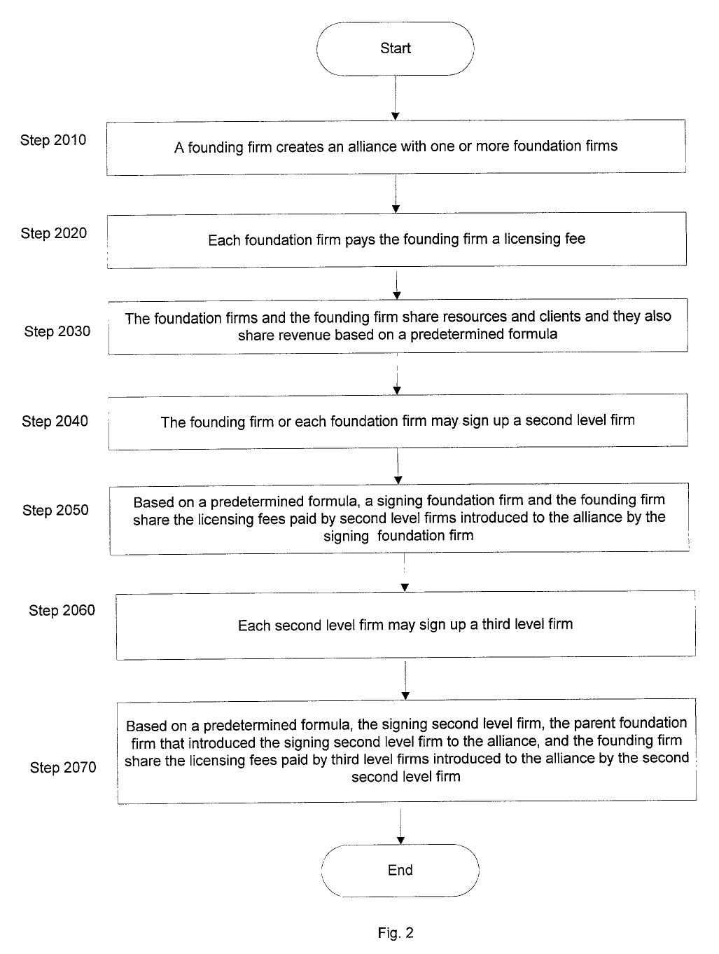

FIG. 2 illustrates the steps implemented in the inventive method for creating multilevel business alliances. In Step 2010, founding firm 102 creates an alliance with one or more foundation firms 104. In Step 2020, each foundation firm 104A-104C pays founding firm 102 a licensing fee. In Step 2030, foundation firms 104A-104C and founding firm 102 share resources and they generally share revenue based on a predetermined formula. In Step 2040, founding firm 102 or each foundation firm 104A-104C may sign up a second level firm 106A-106D. In Step 2050, based on a predetermined formula, a signing foundation firm 104A and founding firm 102 share the licensing fees paid by second level firms introduced to the alliance by foundation firm 104A. In Step 2060, each second level firm 106A-106D may sign up a third level firm 108A-108D. In Step 2070 based on a predetermined formula, second level firm 106A, the parent foundation firm 104A that introduced the second level firm 106A to the alliance, and founding firm 102 share the licensing fees paid by third level firms 108 introduced to the alliance by the second level firm 106A.

The foregoing description has been directed to specific embodiments of this invention. It will be apparent, however, that other variations and modifications may be made to the described embodiments, with the attainment of some or all of their advantages. Therefore, it is the object of the appended claims to cover all such variations and modifications as come within the true spirit and scope of the invention.

What is claimed:

1. A method for creating a multi-level business alliance of independent firms, the method comprising the steps of:
creating an alliance between a founding firm and at least one firm in a first level based on predefined rules;
allowing the founding firm and the firm in the first level to use predefined rules to sign up at least one firm in a second level;
allowing the firm in the second level to use predefined rules to sign up at least one firm in a third level;
providing each firm in the multi-level business alliance the opportunity to access the resources of other firms in the alliance;
enabling firms in the multi-level business alliance to share revenue based on predefined rules; and
accepting firms in the multi-level business alliance that potentially provide a service that is desirable to alliance members.

2. The method of claim 1, further comprising the step of enabling firms of the multilevel business alliance to share revenue based on each firm's position in the multi-level alliance and based on relationships between the firm whose client is being served and other firms that are in higher levels of the multi-level business alliance.

3. The method of claim 1, further comprising the step of defining the firm in the first level as a foundation firm.

4. The method of claim 3, further comprising the step of requiring that the foundation firm is not in a same geographical area as the founding firm.

5. The method of claim 3, further comprising the step of allowing the foundation firm to be a predetermined size.

6. The method of claim 3, further comprising the step of allowing a size of each foundation firm to vary from one geographical area to a next geographical area depending on a size of the founding firm in the same geographical area.

7. The method of claim 3, further comprising the step of allowing multiple foundation firms in the same geographical area.

8. The method of claim 3, further comprising the step of allowing the second level firm to be in the same geographical area as the founding firm or the foundation firm, and wherein the second level firm is smaller than the founding firm and the foundation firm.

9. The method of claim 3, further comprising the step of allowing the second level firm to be in the same geographical area as the founding firm or the foundation firm, and wherein the second level firm is larger than the founding firm and the foundation firm.

10. The method of claim 1, further comprising the step of allowing the third level firm to be in the same geographical area as the second level firm that introduces the third level firm to the alliance, and wherein the third level firm is smaller than the signing second level firm.

11. The method of claim 1, further comprising the step of allowing the third level firm to be in the same geographical area as the second level firm that introduces the third level firm to the alliance, and wherein the third level firm is larger than the signing second level firm.

12. The method of claim 1, further comprising the step of using predefined criteria to determine each firm's levels in the alliance structure.

13. The method of claim 1, further comprising the step of using laws, in each jurisdiction where there is an alliance firm, to determine how revenue is shared among the alliance firms.

14. The method of claim 1, further comprising the step of using laws, in each jurisdiction where there is an alliance firm, to determine whether revenue is shared among the alliance firms.

15. The method of claim 1, further comprising the step of establishing how revenue should be shared based on criteria defined by some of the alliance firms.

16. The method of claim 1, further comprising the step of establishing how revenue should be shared based on criteria defined by a third party.

17. The method of claim 1, further comprising the step of establishing how revenue should be shared based on criteria defined by all of the alliance firms.

18. The method of claim 1, further comprising the steps of:
requiring each firm in the first level to pay the founding firm a licensing fee and wherein the firm in the first level and the founding firm share revenue based on a predetermined formula;
requiring each firm in the second level to pay a licensing fee to a parent firm in the first level and to the founding firm;
requiring each firm in the third level to pay a licensing fee to a parent in the second level that introduced the firm in the third level to the alliance, to a parent firm in the first level that introduced the parent firm in the second level to the alliance, and to the founding.

19. The method of claim 1, further comprising the step of allowing alliance firms in the first, second and third levels to share work and to establish an acceptable revenue sharing agreement.

20. The method of claim 1, further comprising the step of allowing alliance firms in the first, second and third levels to refer clients to each other and to establish an acceptable referral agreement.

21. The method of claim 1, further comprising the step of allowing alliance firms in the first, second and third levels to refer clients to each other and to establish an acceptable referral agreement, wherein the referral agreement requires that a portion of a referral fee is paid to the founding firm.

22. The method of claim 1, further comprising the steps of allowing the founding firm to provide a service to a client of a second firm in the alliance structure and allowing the founding firm to use a predetermined formula to split a referral fee between the second firm and parent firms in higher levels of the alliance structure that introduced the second firm to the alliance.

23. A method for creating a multi-level business alliance, the method comprising the steps of:
creating an alliance between a plurality of independent firms based on predefined rules, wherein the predefined rules determine each firm's position in the multi-level business alliance;
providing each firm in the multi-level business alliance an opportunity to access the resources of other firms in the multi-level business alliance;
enabling at least two firms in the multi-level business alliance to share revenue based on a predefined formula; and
accepting only those firms in the multi-level business alliance that provide service that is desirable to alliance firms.

24. A method for creating a multi-level business alliance, the method comprising the steps of:
creating an alliance between a plurality of independent firms based on predefined rules, wherein the predefined rules determine each firm's position in the multi-level business alliance;
requiring each firm that is not in the highest level of the multi-level business alliance to pay a licensing fee, wherein predefined rules are used to divide the licensing fee between parent firms in higher levels of the multi-level business alliance;
providing each firm in the multi-level business alliance the opportunity to access the resources of other firms in the multi-level business alliance;
sharing revenue among a plurality of firms based on a predefined formula; and
accepting firms to the multi-level business alliance to provide service that is desirable to alliance firms.
